(19) United States
(12) Patent Application Publication
(10) Pub. No.: US 2003/0077396 A1
(43) Pub. Date: Apr. 24, 2003

(54) Dip coating system

(76) Inventors: Robert S. LeCompte, Tucson, AZ (US); Juan Carlos L. Tonazzi, Tucson, AZ (US)

Correspondence Address: DAVID M QUINLAN, PC, 40 NASSAU STREET, PRINCTON, NJ, 08542, US

(21) Appl. No.: 10/278,194

(22) Filed: Oct. 22, 2002

Related U.S. Application Data
(60) Provisional application No. 60/345,971, filed on Oct. 23, 2001.

(51) Int. Cl. B05D 1/18

(52) U.S. Cl. 427/430.1; 118/429

(57) ABSTRACT

Novel features in dip coating apparatus are disclosed which improve the quality of coatings and reduce the cost of the process. These disclosures include modifications to the slide assembly, dip tank design, automatic dip-tank lids, substrate gripping, process control parameters and design of racks to process and store substrates. Also disclosed are sensors and mechanisms to consistently coat the same substrate area.

### CROSS-REFERENCE TO RELATED APPLICATIONS

This application claims the benefit of U.S. provisional application No. 60/345,971, filed Oct. 23, 2001.

### BACKGROUND OF THE INVENTION

Dip coating is used extensively to deposit coatings for a variety of applications. Some of the industries where this is used are related to optics, electronics, medical, automotive and architectural glass. The substrate is dipped in a tank containing a liquid solution and withdrawn from this tank. A layer of solution is pulled along with the substrate. Typically the wet coating is immediately dried either by evaporation, cooling and/or reaction (thermal or radiation driven). The substrates can then be loaded in a rack and fired or heat treated for further coating consolidation. This invention relates to novel aspects of the dip equipment and the process to deposit coatings using the dip process. All the disclosures contained herein can be adapted in a single process/or equipment, or individually depending on the requirements. Further many of the improvements are applicable in other processes also as will be evident below. Further some of the improvements will specifically benefit more rigid substrates such as glass, metals, ceramics and plastics. Although the invention primarily addresses flat substrates, the principles can easily be used for other substrates which are bent or curved, prisms and cylinders, hollow and solid bodies and bodies with holes or apertures.

Dip coating is extensively used on a commercial scale in depositing coatings in electro-photographic and magnetic coating industry as seen in patents and applications JP0923081, JP62108627, JP11191186, JP10284960, US6180310B1, U.S. Pat. Nos. 6,132,810 and 5,976,633. Commercial dip processes are also used to deposit corrosion-resistant coatings on metals, coatings on cardboard, ion-barrier layers on glass for displays, anti-reflective coatings on glass, primers on substrates, etc. The prior art mentioned above may further benefit from the present invention. The dipping invention mentioned here can also be applied to those processes where dipping is used as an immersion bath and the coating process is assisted by additional parameters, such as by electrical and thermal fields in electroplating, electrophoresis and thermophoresis, etc. Some of the embodiments described in firing rack designs of this invention can be used for almost any coating process such as wet-chemical or physical vapor deposition process. The embodiments related to grippers may be used in any other processing other than dip coating where the substrates have to be moved by holding them close to their edges.

### BRIEF SUMMARY OF THE INVENTION

The invention improves several aspects of the dipping process and equipment which result in improved coating quality, reproducibility, enhancements in productivity and lowering the cost of process-equipment and coatings deposition process. These are mainly related to improved dip tank designs, substrate gripping, firing and storage racks for substrates and processing of the coatings. Specifically these are:

1. The changes in the dip machine allow a constant area to be coated, even as the coating solution level drops in the tank. In addition, this mechanism can be integrated with other features so that when the liquid level falls too low, the substrate does not hit the bottom of the tank and the gripping mechanism does not strike the edge of the dip tank.

2. Many of the coating solutions are volatile. Thus when a substrate is pulled out, the evaporation from the tanks can damage freshly coated surfaces, or, as the solvent is lost, the concentration of the active ingredients in the tank changes leading to issues related to reproducibility of thickness, coating properties, etc. The invention substantially reduces this problem. A novel automatic tank cover is described in the invention to reduce this effect.

3. The improvements in the dipping tank lead to a decrease in coating solution volume requirements, easing cleaning of tanks and decreases particulate contamination which may be caused as a result of tank fabrication processes.

4. The improvements in the racks leads to reduced damage at the points where the substrate touches the racks, decreases damage due to thermal expansion upon firing, and accommodates a variety of sizes and shapes without changing the rack itself.

5. A dip system is also described with many novel features. This may be integrated in a continuous process or be a part of a batch process.

6. Grips to hold substrates are also described which hold the substrates in precise positions without causing any damage while gripping onto a small area (footprint) on the substrate.

### DESCRIPTION OF THE SEVERAL VIEWS OF THE DRAWING

FIGS. 1A, 1B, and 1C show a schematic of the dip process with liquid level sensor and a limit switch in accordance with this invention.

FIGS. 2A and 2B shows a schematic of the dip process with an automatic lid according to this invention.

FIG. 2C shows the details of a controller for the automatic lid.

FIG. 3 shows a schematic of a dip tank construction in accordance with this invention.

FIG. 4A shows a drawing of a rack holding circular substrates according to this invention.

FIG. 4B shows a drawing of a rack holding square substrates according to this invention.

FIG. 4C shows a drawing of a rack capable of holding circular substrates of various sizes according to this invention.

FIG. 5A shows an isometric view of the rack according to this invention.

FIG. 5B shows an isometric view of the rack holding substrates according to this invention.

FIG. 5C shows an isometric view of stacked racks of this invention.

FIG. 6A shows arrangements of substrates in grooves of the rack according to this invention.

FIGS. 6B and 6C show details of the groove and substrate support according to this invention.

FIG. 7 shows schematics for a dip system according to this invention.

FIGS. 8 and 9 show a substrate grip mechanism according to this invention.

### DETAILED DESCRIPTION OF THE INVENTION

### Improvements to the Dip Machine: Maintain Constant Coated Area

In the dipping process the fluid level drops as substrates are dipped. This is because some of the dipping fluid is carried away by the substrate which results in the coating, and also due to the evaporation of some of the components in the solution or due to possible leaks in the tank. Many attempts have been made to keep a constant area of coating. For example JP06118039 discusses a method where the dip tank is like a conical pyramid and the plates are pivoted at the apex of the cone. The plates are rotated about an axis to squeeze the dipping fluid to maintain a constant fluid height. This method is difficult to control because the cavity is conical and the angle of the cone changes. When a substrate is pulled even at a constant speed, the rate at which the interface of the fluid in the tank separates from the substrate is not constant resulting in non-uniform thickness.

Another way to maintain a constant level is to circulate solution continuously into the tank along with a siphon or an overflow valve at a predetermined height This method is expensive as it requires a system of corrosion resistant pumps, stable meniscus while adding fluid, temperature control on fluid being added and a good homogenizer along with costly maintenance procedures. An example of this is in US6180310B1. Our invention described below overcomes such issues.

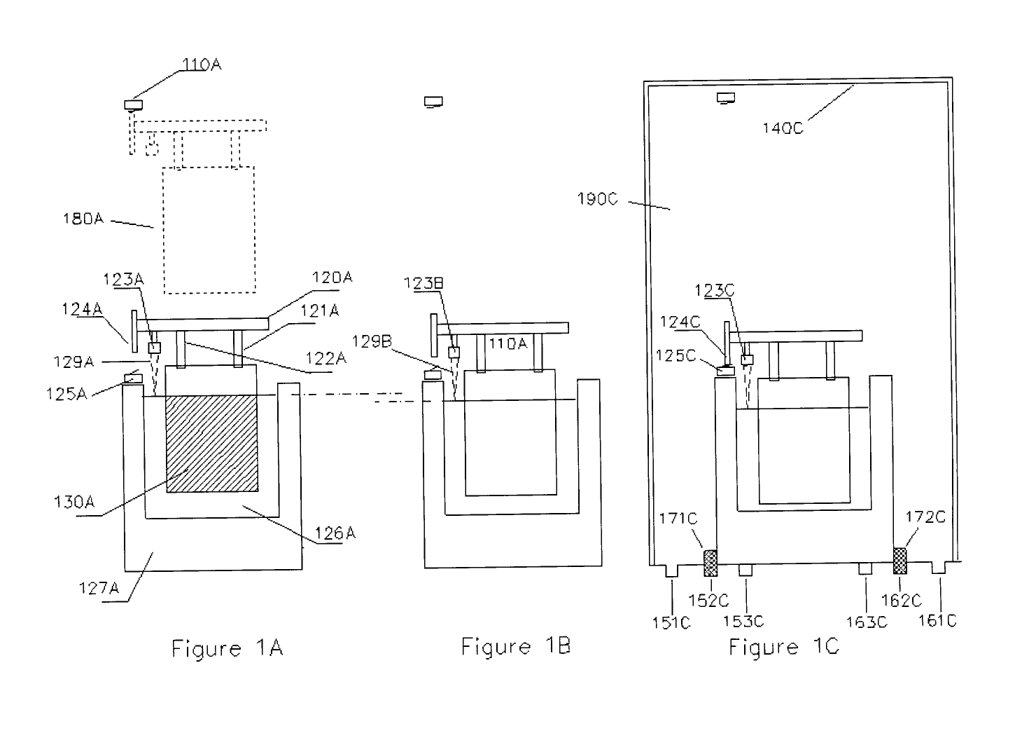

FIG. 1A shows schematics of a dip machine made by this invention. The gripper assembly 120A holds a substrate 130A that has to be coated. The substrate is inserted in a dip solution 126A that is contained in a dip tank 127A. The shaded part of substrate 130A is in contact with the solution and will be coated. Liquid sensor 123A is mounted on the gripper assembly. This senses the level of the liquid in the tank by a non-contact method (see light beam 129A). Non-contact means that no physical part of the sensor contacts the liquid. Contact methods can also be used, but non-contact methods are preferred to avoid contamination and reduce maintenance. Also shown is a limit switch 125A on the tank that is activated when it comes in contact with the striker 124A mounted onto the gripper assembly. When the gripper assembly travels up withdrawing the substrate, then this striker (124A) or another striker (not shown) comes in contact with another limit switch 110A and stops the travel of the machine (this is shown by dotted lines 180A). The coated substrate is replaced by an uncoated substrate and the process of coating is again initiated. The gripper assembly travels down and immerses the substrate in the dip tank while the sensor 123A checks the distance from the dip solution surface. At a pre-determined separation between the sensor and the solution surface the gripper assembly stops so that the substrate is coated to a fixed depth. After a pre-determined delay the gripper assembly then withdraws the substrate out of the tank and the cycle begins again.

After this process is repeated many times, the liquid level in the tank decreases as shown in FIG. 1B. The primary cause of this reduction is the coating solution pulled out in each dip process, although other processes such as evaporation of some of the solution components may also lead to a decrease in the coating solution level. Since the sensor 123B in FIG. 1B keeps the same pre-determined distance from the liquid level (see light beam 129B, which is same dimension as 129A in FIG. 1A), the depth of the substrate coated is consistent every time. If the gripper holds the substrates similarly, the coated area will be identical for the same width and the thickness of the substrates.

As the dipping continues, the level of solution falls to a point, where the substrates may hit the tank bottom or the gripper may hit the tank edges, if the distance between the sensor 123C (see FIG. 1C) and the liquid level is maintained to the same value. To avoid this, the striker 124C touches the limit switch sensor 125C and stops the machine and provides a low liquid level warning. More fluid can be added manually or automatically and the operations started again.

Although this diagram shows one substrate being dipped, there may be several substrates held by the gripper at the same time in a parallel fashion spaced apart by some pre-determined distance which allows the coatings to dry without interference of evaporation effects due to the constricted gap amongst them. Other ways may be employed to monitor coating solution level. The additional coating solution can be added manually or automatically. The automatic addition may be continuous or after a certain depletion in liquid level is detected. Not shown are constant temperature coils, which can be added inside the tank or as a jacket outside of the solution area to maintain constant temperature. This is done in order to control the viscosity (as this is a strong function of temperature) of the fluid in a tight range as it influences the coating thickness. For example FIG. 1A shows a non-contact dip solution level sensor 123A (optical type such as PS-47 or PS-49 sense head with a PS2-61 amplifier from Keyence (Woodcliff Lake, N.J.)), but they can be any appropriate sensor including other type of non-contact (such as those based on ultrasonic technology) and contact sensors. Similarly, the low liquid switch and the upper stop switch shown here are mechanical, but these may be non-contact type switches as well. One may even sense the concentration of the coating ingredients and then add solvent or solution to the tank to maintain a constant concentration of the ingredients. Especially if solvents with high volatility are used then this may be needed. Many of these features can be combined depending on the extent of control and required product consistency.

### Improvements to the Dip Machine: Automatic Tank Cover

When the dip tank is not in use, it is best to cover it with a lid. This prevents inadvertent evaporation of any of the dip solution components from the tank, protecting the solution from contamination from any atmospheric particles and also helping the surface solution maintain a constant temperature, thus reducing surface convective currents. Usually a manual dip tank cover is used which is placed on the dip tank when the machine is not in use, however, there is no protection while the machine is in use, particularly between subsequent dip cycles. In some cases the evaporating solvents from the tank may even spoil a freshly dipped substrate as it is being held over the dip tank. The automatic cover or the lid of the invention is defined as a cover which opens automatically when a substrate is about to enter the tank and closes automatically after the substrate is withdrawn from the tank.

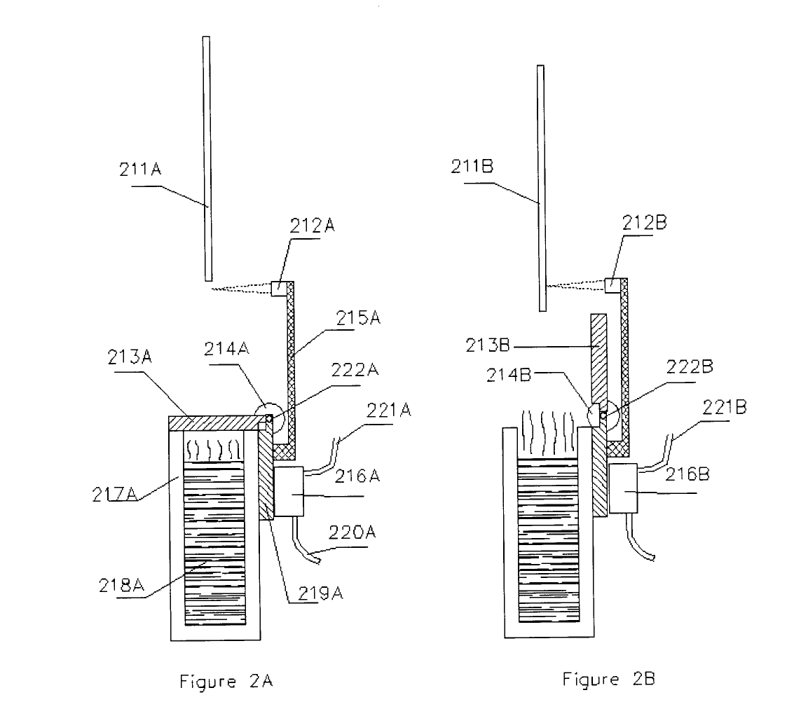

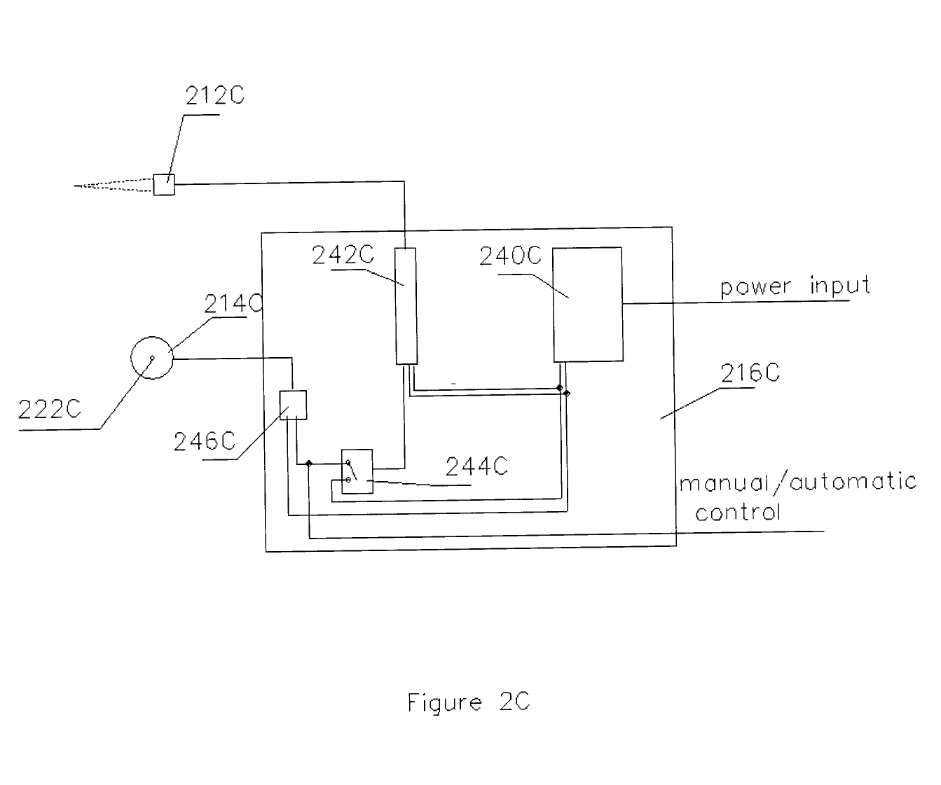

FIG. 2A shows a novel implementation of an automatic lid. The dip tank 217A which contains the dip coating solution 218A is covered with a cover 213A which is automatically actuated as described below. The automatic cover assembly is comprised of a cover 213A, hinge 222A, actuator 214A (a mechanical link to a moving interface defined in FIG. 2C) and an attachment plate 219A. The control box 216A is for processing the signal from the sensor 212A and actuating the cover 213A via the actuator 214A by rotating it around the hinge 222A. Also shown is a sensor (non-contact in this case) 212A, which locates the presence of the substrate being dipped (211A) as its end moves past its sensing area. The sensor 212A is attached to a support structure 215A, which is further mounted on the attachment plate 219A. FIG. 2B shows that as the substrate 211B moves past the sensing region of the sensor 212B, the actuator 214B gets a command from the control box 216A and opens the cover 213B by rotating around the hinge 222B. The substrate is then dipped in the tank and as its end is pulled out past the sensing head region, the lid again closes. The control box 216A in FIG. 2A is shown with a power cord 221A and a wire which connects this to the main control system (which controls all functions of the dip system, such as PLC controller (examples are KV series from Keyence, PLC is programmable logic controller) via 220A. Both 220A and 221A can be corded together and connected to a main controller both for power and actuation command.

FIG. 2C shows the details of a stand-alone control box 216A of FIG. 2A. As discussed earlier, this box can have local control and/or manual override. The control may optionally be also provided via an external controller which provides control to the other functions of the dip machine. Such a controller will be discussed later. The controller 216C has several components. It has a power conditioner 240C which provides power to both the optical sensor amplifier 242C (Keyence amplifier PS2-61) and the optical sensor 212C (such as Keyence PS-47 or PS-49)) and a relay 244C. When the relay is activated from a command issued by 242C it goes through an interface 246C to move the actuator 214C. The interface 246C may be a solenoid, pneumatically or hydraulically activated lever, etc.

The above figure only shows an embodiment to implement the automatic cover option. One may mount the cover assembly onto the tank or it may be mounted separately on another part of the dip system. This can be combined with the feature described earlier, i.e., the liquid level sensing system. For the embodiment shown in FIG. 1 a central controller will activate the solution level sensor only when the lid opens. The lid design can be any type, such as sliding, folding or any other means which would accomplish the purpose. The sensor may not be mounted on the automatic cover assembly, or the automatic lid itself may not be physically mounted on to the dip tank. All communications with a control system may be through a wired connection as shown by 220A or these may be wireless. One such option of wireless control is via the Blue Tooth modules. These wireless modules can be used to communicate between the other subsystems and a centralized controller. For a given substrate geometry the opening and the closing of the tank cover may be activated by limit switches or it may be timed after also taking into account the dipping conditions (such as the speed of dipping and withdrawal). The parameters for timing may be programmed into a microprocessor such as a PLC (programmable logic controller).

### Improvements to the Dip Tank

This improvement significantly reduces the volume of the fluid tank without sacrificing the advantages of a tank with wide opening, which traditionally requires more fluid. An advantage to having a wide opening at the top is the ability to limit the meniscus movement due to the displacement of the fluid as the substrate is lowered or pulled out of the tank. A tank that narrowly conforms to the shape of the substrate (meaning the cross-section of the substrate) being dipped will reduce the quantity of the solution required. The replacement cost of the fluid can be high, particularly for those coating fluids which age rapidly. A narrow tank can decrease the expense of the solution as less of it is required in the tank. However, if the tank is narrow, the displacement of the meniscus is large, resulting in non-uniform coating. This non-uniformity arises because as the substrate is pulled the meniscus in the tank drops sharply due to large displacement of the liquid relative to the tank volume. The vapor pressure of the solvents from the dip solution is too high in this narrow air filled volume above the meniscus and the vapors are unable to vent properly. This inhibits drying and also it can re-dissolve the freshly deposited coating layer, giving rise to non-uniformity. This invention combines advantage of both the narrow and the wider tank systems as described below. Further, it also describes tank constructions so that they are inexpensive and easy to assemble and clean. Although the embodiment below describes systems for coating thin flat substrates (meaning where both the width and the depth exceeds about 10 times the substrate thickness) the principles are easy to extend to bent sheets and solid and hollow bodies such as prisms and cylinders.

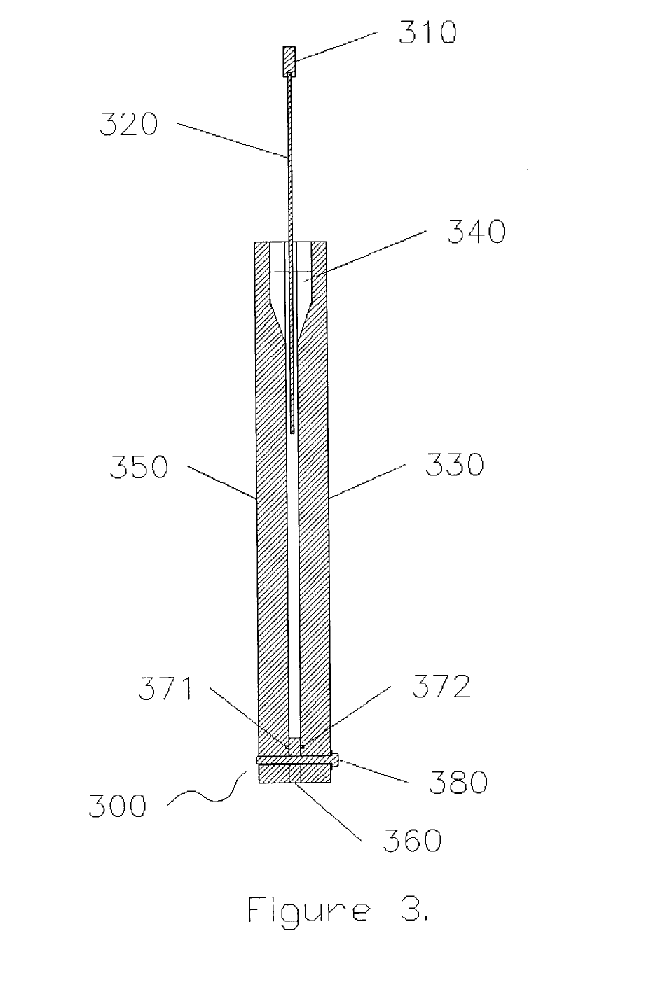

FIG. 3 shows the cross-section of a dip tank 390 made according to the invention. Also shown in this figure is a substrate 320 being dipped in the solution 340. A moving gripper assembly 310 grips the substrate 320. The width of the tank at the top is wider than the width towards the bottom. It is important to maintain a wider surface from where the substrate is being pulled from the liquid to the air or gas interface. This keeps the turbulence in the meniscus low. Typically this width should be at least four times the thickness of the substrate, and preferably more than 10 times the substrate thickness. However, if a tank is made with a uniform width of 10 times the substrate thickness, then the required volume of solution is high. It is preferred that the meniscus displacement during withdrawal of the substrate occurs only in the wider area and not in the neck area (i.e., the transition area from the wider segment to the narrow segment of the dip tank). This is to keep the dipping speed constant all through the process. Also the non-uniformity in the coatings caused by the high vapor pressure in the narrow segments of the dip tank cavity will not be an issue. Alternatively, if one requires a coating with thickness gradient, the top part of the tank can be profiled accordingly, i.e., conical. Towards the bottom, the thickness of the tank can be as thin as possible so that the substrate does not touch the well walls. In one scenario when we used substrates ⅛^{th} inch in thickness, the bottom width of the tank was about ⅜^{th} inch. In this exemplary scenario the tank in the wide section was 1⅜ inch wide.

During dipping, the solution should not flow out of the tank due to displacement or the level fall into the neck area. For this, the volume of the solution in the wide segment should be at least equal to the volume of the substrate being dipped, more preferably it should be more than two times and most preferably more than 3 times the substrate volume. One can go from the wider region to the narrow region in a step, but it is preferred to have a gradual neck region or transition as shown by 355 in FIG. 3. One reason for having the taper from the wide to the narrow regions is to avoid substrate(s) crashing on the sides of the tank or on this step if there is any misalignment. As discussed later, other novel disclosures in this invention overcome the issue of misalignment of the substrate when it is held by the grippers and precise positioning of the tanks. A uniformly narrowing neck region with a taper angle between 10 and 25 degrees with the vertical axis is preferred. Tank section perpendicular to the view in FIG. 3 is not shown. For a sheet this section can be uniform from top to bottom and at least as wide as the substrate being dipped. We have successfully used tank widths of about 1 inch or more in excess of the substrate width.

Tanks can also be made by machining a slot cavity in a block of material. In order to fabricate large area dip tank (with a depth which cannot be machined inexpensively as a slot), one can use the construction as shown in FIG. 3. The dip tank consists of two sides (outer sections) 330 and 350 separated by an insert (or spacer) 360 (sandwiched section). The insert is “U” shaped and seals tightly against the sides by the two “O” rings 371 and 372 with a series of bolts 380 running across the tank bottom and the sides. Thus this insert determines the width of the narrow section. One may use a thicker “U” section in order to increase the width of the narrow section. First, the insert can be changed to any desired width depending upon the substrate thickness, number of substrates, coating solution viscosity, solution cost, etc., without having to change the other components of the dip tank. Second, it is easy to dissemble the tank for cleaning. Third, the cost to make the sides is reduced, as only the top region needs to be machined. Micro-cracks or burrs on the tank surfaces exposed to the solution may result in coating solution contamination due to the surface not being cleaned as easily as a smooth surface. The skived surfaces of a plastic slab provide a higher quality surface at low cost. For very small tanks such as those with depths of less than or about 6 inches, one may use an end mill to make a cavity in one block. Another variation in construction can be where all the taper is only on one of the plates of FIG. 3, i.e., 350 is tapered as shown and 340 is made flat with no taper at the top.

Typically in dip coating the tanks are placed below the moving substrate by approximate eyeballing and a few trial and errors. When such tanks with interior dimensions close to the substrate thickness are used, it is important to place these precisely in a location so that when the substrates are dipped, then they do not hit the tank sides. To prevent this, a novel idea of incorporating locating pins or blocks on the table or platform on which the tank is placed is described. This is shown in FIG. 1C. This shows three sets of locating pin wells. These are 151C and 161C; 152C and 162C; and 153C and 163C. Depending on the size of the tanks the locator pins can be placed in the desired location (which are preferably removable and screw or fit snugly in these holes). One such set is shown as 171C and 172C. Since this diagram is a two dimensional section only pins along this section are shown. It is preferred to have these pins on at least two adjacent sides, preferably one on each side of a rectangular tank and three for a circular tank. Thus when the tank is removed and placed on the table, it can be located in precise position as long as the external dimensions are machined to fit within these pins or blocks. Although these pins are more useful for the tanks of this invention as they can have narrow cavities, they can be also used for dip tanks of any other type.

### Substrate Storage/Firing Racks

Racks for storage are extensively used to store planar or curved sheets of materials. Many times while they are on the rack they are also processed such as by heat and/or subjected to environmental exposure. Some examples of applications are glass and plastics sheets for automotive, architectural, display, solar panel and optics industries; silicon, glass, ceramic and composite boards for electronics and solar industries. The substrates have to be stacked in racks and processed without damaging them or the coatings or features present on their surfaces. These should be easy to transport and provide flexibility for the users to tailor them for specific sizes. These racks should leave no residue on the substrates as they may interfere with the performance of the products resulting from such substrates. Many substrate racks are described, such as those in U.S. Pat. Nos. 5,641,076 and 4,899,891. In U.S. Pat. No. 4,899,891 there are extended fingers which separate the glass sheets and touch substrate surfaces in the central area. U.S. Pat. No. 5,641,076, describes racks for glass sheets where these are stacked in “V” grooves of soft materials. The grooves are not shaped optimally and it is not possible to take these racks into firing or chemical environments. If such racks are stacked when empty for storage, they may result in a fragile column. In U.S Pat. No. 4,498,832, little thought is given to the nature of grooves to hold the substrate from their edges and how these can be modified to leave minimum impression on the substrates. U.S. Pat. No. 4,775,317 describes silicon wafer holders which can be loaded and processed in ovens under flowing gasses, however, they do not describe the nature of grooves from where the substrates are held in place. The racks of this invention provide many novel features. Depending upon the requirements, all or one of these can be incorporated in the rack. These are:

1. Guiding of the substrates in fixed grooves without precisely aiming for the grooves for individual substrates.

2. Storing of substrates without pinching their edges.

3. Ability to heat and cool them to high temperatures without pinching and damaging substrate edges due to mismatch in the thermal expansion of the rack material and the substrate.

4. Easy for gases to flow between each of the substrates for processing.

5. Easy to adjust and adapt them to a variety of substrate sizes, shapes and thicknesses.

6. Storing substrates in a stable fashion so that they are not knocked out of position easily.

7. Easy to roll the racks so that they can be positioned without lifting heavy loads.

8. Easy to stack for storage when empty.

These storage racks can be used for heat treating substrates and storing. The racks of this invention can be used in any process where the above advantages are required, such as in optical industry, glass and plastics processing industry, semiconductor industry, etc. Further, the novelty of the concepts will be described by giving specific examples, but these can be adapted for different shapes, or very extreme sizes in terms of thickness and area dimensions.

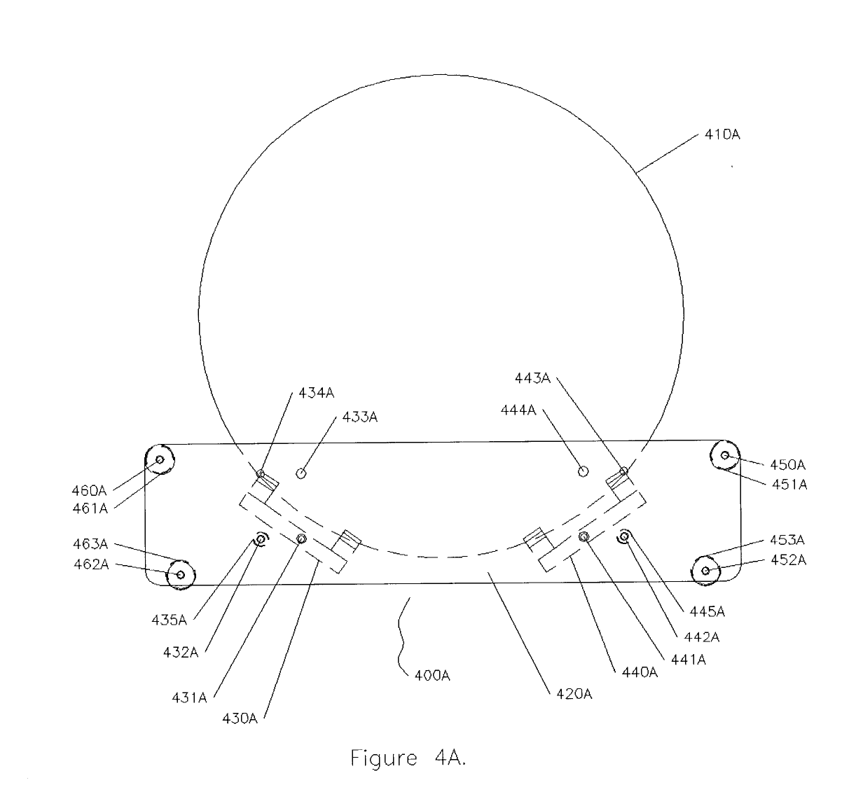

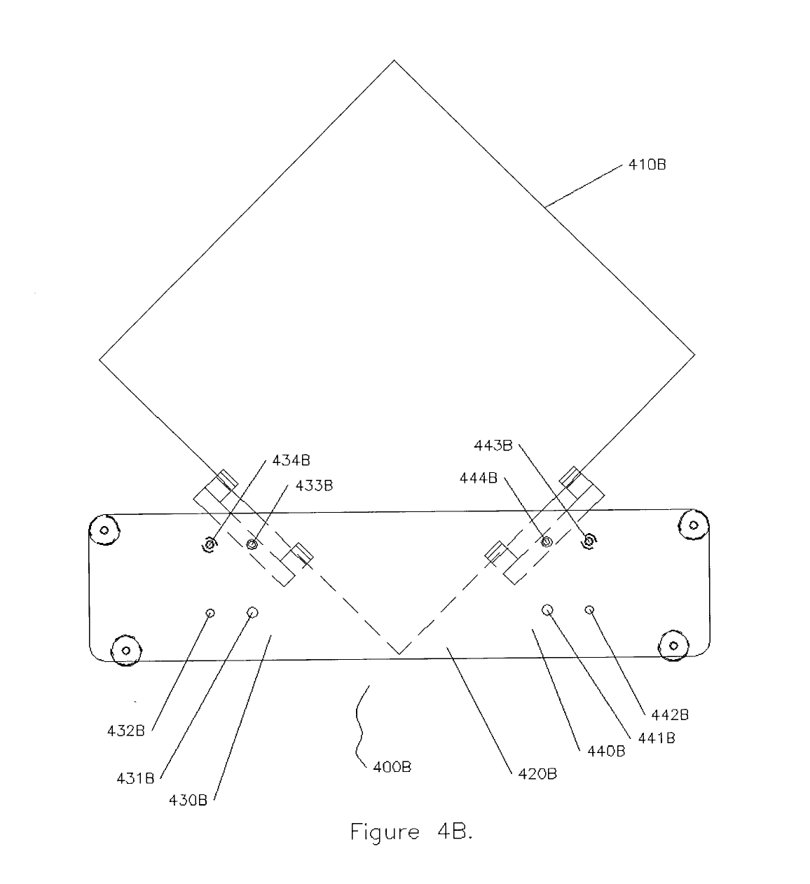

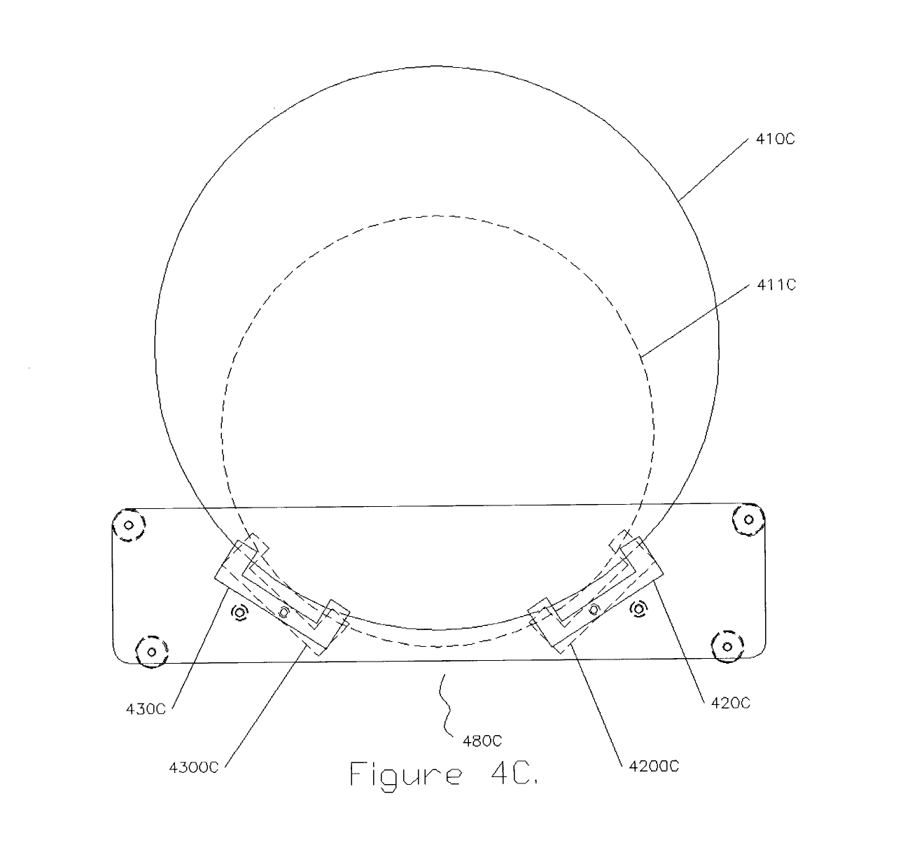

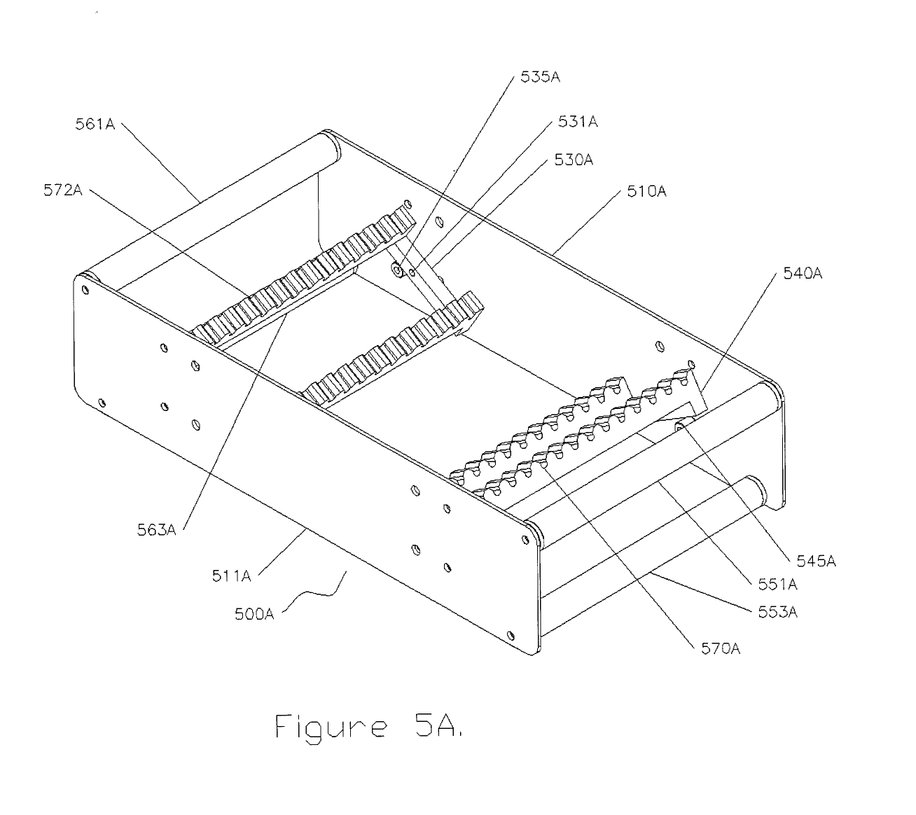

FIG. 4A Shows a rack 400A that has a circular substrate 410A stored in it. This is a frontal view of the substrate. If the racks are subjected to high heat treatment temperature such as 500° C., they can be fabricated out of stainless steel. This material allows the racks to be included in processing under corrosive environments, and to high temperatures without leaching any residues from them. The construction material for racks can be any depending on the intended use including polymers and ceramics and other metals. The rack in this figure consists of two structural plates 420A and the one opposite to it (not shown). These are fixed rigidly by four rods 461A, 463A, 451A and 453A, which are bolted to the plate 420A and to the opposite plate. There may be more than two parallel structural plates that are held by the same four rods, or new sets of rods can be used between each set of two parallel faces. These rods can be of any shape in cross-section, but it is preferred that the ones at the bottom (463A and 453A) are circular to impart optional functionality as described below. The top ones (461A and 451A) may even have additional handles and grip features as needed. This figure shows that the rods 463A and 453A protrude from below the structural plate 420A. This is because the rack rests on them, and further it rolls on them when the racks are pulled. Shoulder bolts affix these rods so that they are able to rotate. The top ones 461A and 451A are bolted tight so that when these bars are grabbed for lifting or pushing/pulling they do not rotate. These bars are made out of hollow stainless steel cylinders to keep the rack weight low. Caps at either end are press fit onto these cylinders to be able to fasten them with bolts. The substrate rests on grooved brace sections 430A and 440A (the details of the grooves are discussed later). The shoulder bolts (431A and 441A) provide pivots for the rotation of these supports. The pivot points are so located so that if there is no substrate, these will rotate and come to rest on the respective support 435A (attached through the hole 432A) 445A (attached through the hole 442A). When a substrate is put on the grooved brace sections, these rotate due to the weight of the substrate so that they lift from the support and snugly fit around the substrate. This allows these racks to be used for several different sizes of substrates as discussed in more detail later.

If the pivot point of the grooved brace sections and the support bolt are moved to holes 433A and 434A respectively, and the same is done for the other side, then square substrates can be accommodated. This is shown in FIG. 4B. The pivot points are shown as 433B and 444B. The grooved brace sections 430B and 440B are supporting a square shaped substrate 410B. Thus one can have a series of holes in the structural plate 420B and correspondingly in the opposite plate (not shown) to accommodate a very large range of substrate shapes and sizes only by shifting the grooved brace sections positions.

In these racks, each of the positions of the grooved brace sections can accommodate several sizes. This is illustrated in the rack 400C as shown in FIG. 4C. This shows a rack similar to the one in FIG. 4A. The solid lines show that the grooved brace sections 430C and 420C hold a set of substrates 410C. If these substrates were removed, and substituted for a different sized substrate 411C (shown dashed), then the grooved brace sections toggle by a rotation motion to accommodate them. The new positions of these are shown by dashed lines as 4200C and 4300C. Along with this feature and a series of holes as described in FIG. 4B, these racks can accommodate a very large range of shapes and sizes, in many cases with no changes. Such flexibility in tooling is always appreciated in the production environment.

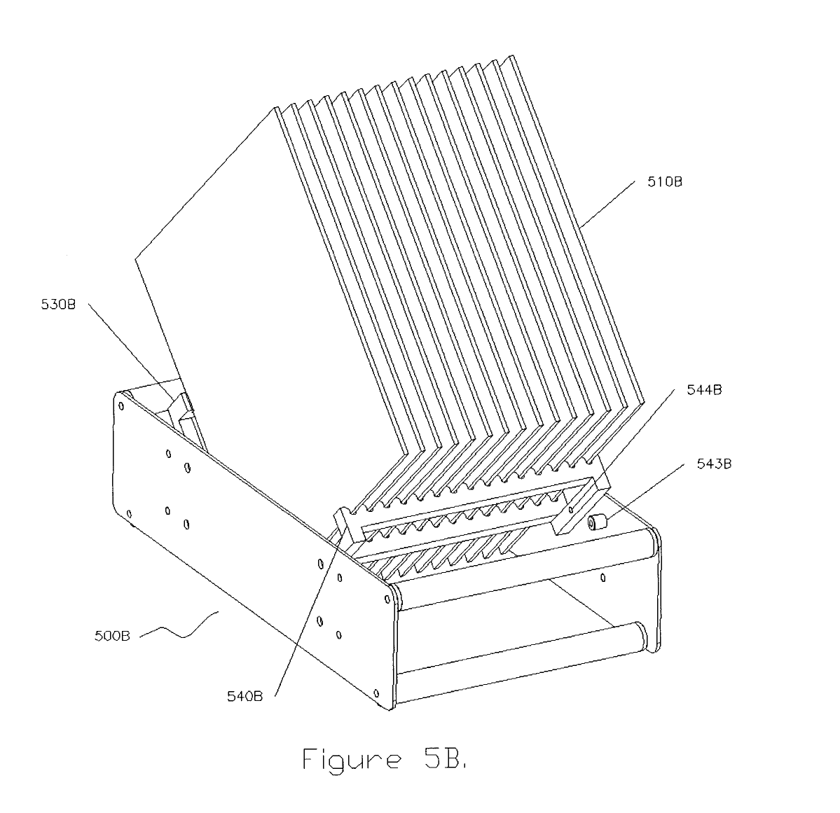

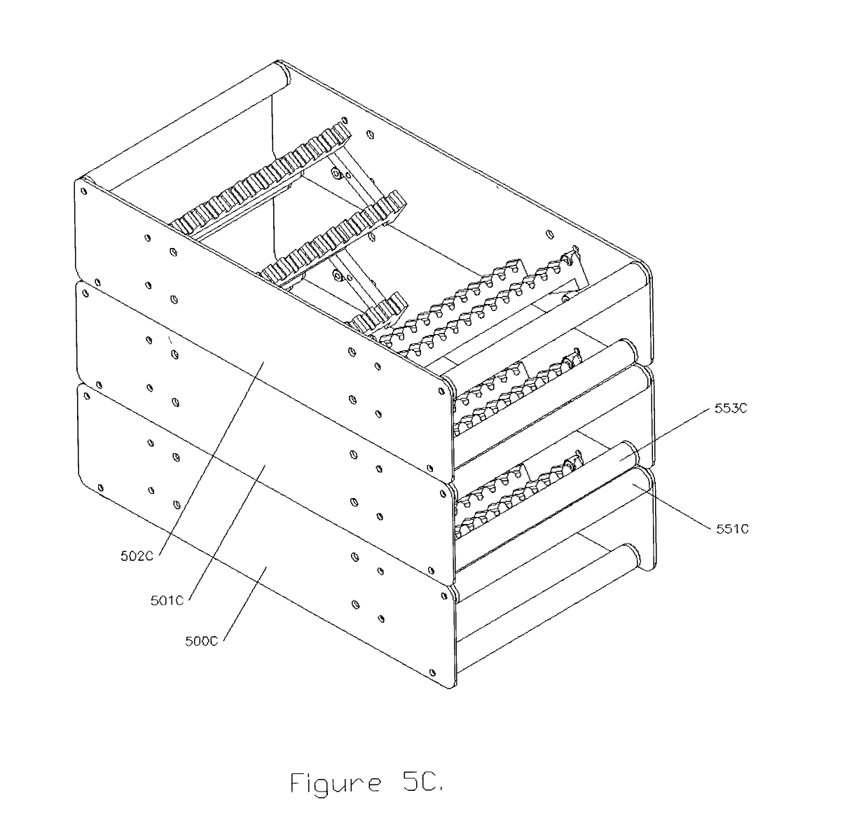

FIG. 5a shows an isometric view (500A) of the rack discussed above. This shows the structural plates 510A and 511A. The four rods holding the plates are 551A, 553A, 561A and 563A. The bottom rods, i.e., 553A and 563a also serve as rollers, as indicated earlier. The grooved brace sections 530A and 540A are also shown. These are pivoted on both sides to these plates. The pivot point and the support point for 530A on structural plate 510A are 531A and 535A. Also, when the rack is empty the grooved brace sections rests on support point, as shown for 540A resting on 545A.

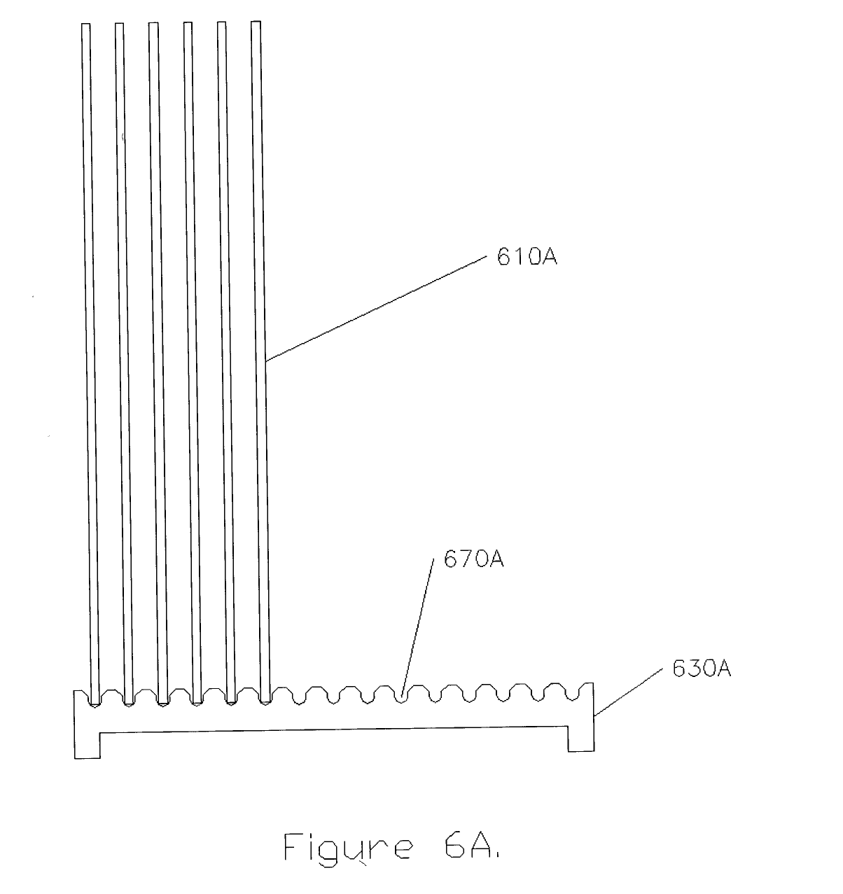

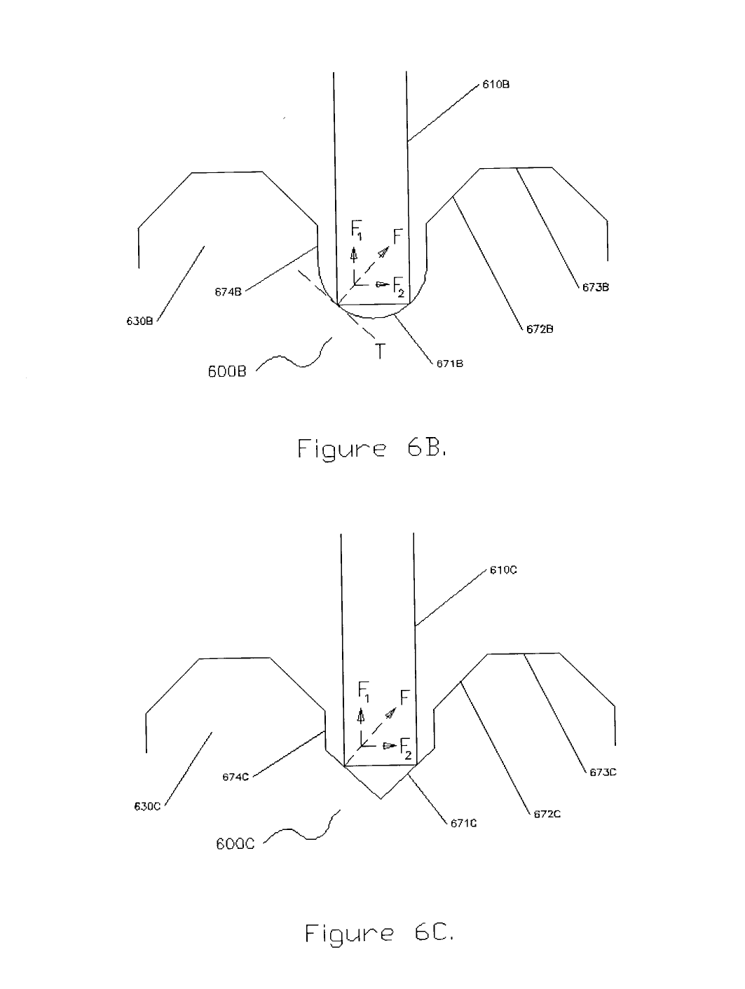

FIG. 5B shows when the rack 500B is loaded with a large number of substrates 510B. The grooved brace section 540A rotates around the pivot 544B and thus moves away from the support point 543B. A corresponding movement takes place at the other grooved brace sections 530B. The substrates are positioned in the grooves of 540B. This is shown more clearly in FIG. 6A. Another advantage of this rack is accessibility of the space between the substrates to flowing gasses as long as the racks are oriented so that the “substrate surface normal” is perpendicular to the gas flow. This helps to process these substrates in chambers where the gases must contact the entire substrate area.

FIG. 5C shows the stackability of the racks where three such empty racks 500C, 501C and 502C are stacked on each other. The top handle 551C of the bottom rack 500C does not interfere with the bottom roller 553C of the upper rack 501C. This is because these are offset from one another. This can be better appreciated in FIG. 4A and one can clearly see that the roller 453A is offset from handle 451A and the same for 463A and 461A respectively. Further, since the rollers protrude out of the support plates (See the plate 420A in FIG. 4A), and are inside of them, they provide a natural locking mechanism, so that the racks do not slide in the stacked position. The grooved brace sections rotate due to gravitational forces and fold inside of the structural support plates and rest on the support point.

FIG. 6A shows how each of the substrates 610A are stacked in the groove plate 630A inside each of the grooves 670A. The shape and sizing of the grooves is very important to properly support the substrates, and not pinch the sides, and in maintaining the non-pinch feature when the loaded racks are heated and cooled. This will be discussed while FIG. 6B is examined.

FIG. 6B shows a highly magnified view of the grooved plate 600B with one groove 670B. This also shows a substrate 610B. The groove consists of several features. It has a rounded cylindrical part 671B. This can be a complete semi-circle or a part of a semicircle or elliptical, generally described as circular. This is followed by primarily a straight edge 674B and then it diverges in any convenient fashion as shown by 672B. Before the diverging part, one may describe this as a “U” shaped channel with the rounded part at the bottom followed by a vertical section.

As shown, the substrate 610B rests on the very tip of its edges in the groove 671B without being pinched. When these racks are heated along with the substrates, the differential expansion or contraction between the two will move the edges in the groove smoothly without a pinch effect as explained below. This figure shows a tangent T at the point of contact and a normal force F which is generated perpendicular to it due to the substrate weight and the expansion pressure generated. This force has a component F1 which acts in the vertical direction, as long as the frictional resistance is small, to allow the vertical movement so that the substrate will not be pinched. It is preferred that the coefficient or friction between the two (substrate and the groove material) should be lower than 2.5 and preferably lower than 1. Also, so that there is a substantial resultant force in the vertical direction, it is preferred that the substrate thickness should be in the range of 0.2 to 0.95 or most preferably be in the range of 0.5 to 0.7 times the diameter of the circular groove 671B. Also, if the substrate is too thin relative to the diameter of the groove, then the substrates will wobble, and can be damaged at the edges. If this is substantially similar to the groove diameter then these can be pinched and distort or damage either the racks or the substrates, particularly at higher temperatures. Although the groove is shown to be circular, it can be any similar shape as long as the above description applies. However, from a machining perspective, it is cheaper and easier to use a ball end mill and make these grooves circular. Alternatively, these can be made out of sheet metal and a punch and die set can be made to resemble the shape of the desired groove pattern for groove fabrication.

FIG. 6C shows a different kind of grooved plate section 600C which has a “V” shaped bottom groove (671C) followed by a vertical step (674C) on each side that provides the same resistance to the substrate “walking” out of the groove if the rack is tipped or the substrate is pushed sideways in the groove. The maximum opening of the “V” is also governed by the substrate thickness as for the above case, where this opening is substituted for the diameter. In addition, preferred V angle is between 30 and 75 degrees. Since, this is similar to the above description in the sense that there is a groove followed by vertical sides, we will define this geometry also as “U” shaped from a claims perspective. In all these figures the substrates are shown with square edges, which may not be the case, e.g., they may be rounded. Whatever their edge definition may be these principles still apply as long as the right forces act at the contact points of the substrates and the rack grooves.

The vertical part 674B in FIG. 6B (or 674C in FIG. 6C) is also significant. The determination of distance between the vertical parallel lines of the “U” has been described above. When the substrates are loaded, the shallow cylindrical grooves may have to support substantial weight and the movement generated by the substrates as racks are transported or while in storage. Thus the vertical edges provide this support and do not allow the substrate corners to be damaged or the substrates to dislodge from the grooves. This vertical height depends on the substrate size (dimensions and weight) and the area near the edges which may periodically contact the substrate surface without interfering with the critical components which are mounted or deposited on the substrate. This vertical height is typically greater than 0.002 inches. For example, for glass substrates which were about ⅛ inch thick and about one square foot in size (squares or circles), the groove diameter which gave acceptable results was 3/16th inch and the straight parts (674B) were 1/16th inch high. The material for the grooved support plate was stainless steel.

The diverging part 672B in FIG. 6B or 672C in FIG. 6C is also significant. If the grooves only consist of 671B and 674B, then one has to carefully aim the substrates in the grooves. This results in more operator time costs, and may also lead to errors, where the substrates may not properly seat in the grooves. This divergence simply provides a means of easily placing the substrates in a wider opening, and they slide into the grooves without damage. The shape of these can be any as long as they do not touch the sides of the substrates during loading/unloading or processing. For the glass substrate dimensions defined in the above paragraph, we found the depth of these chambers of ⅛th inch and the width of ⅛th inch at the top to be sufficient. These 45 degree chamfers may be changed to almost any angle, but, for a given groove depth the range of 30 to 60 degrees gives a wider or narrower “target” to hit when loading the rack. The decision to use 45 degree chambers was predicated by standard machine shop tooling. The preferred range is that the maximum width of the divergence is greater than 2 times the distance between the parallel sides of the “U” and more preferably three times.

A rack designed as shown in FIG. 5A was made to hold 15 substrates, either circles or squares, for a range of 8 inch×8 inch to about 12 inch by 12 inch and 0.125 inch thick glass. The length of the racks was about 14.69 inch, the height was 3.5 inch and the width was 8.25 inches (i.e., length of the rods (553A, 551A) plus the thickness of the structural support plates 511A and 510A). The thickness of the structural support plates were 3/32 inch each. The diameter of all the rods connecting the two structural plates was ¾ inch. The centers for the grooves in the groove plates were ½ to 1 inch apart.

In all of the above descriptions specific rack designs were used to explain the novelty. There may be many variations of this theme, such as “L” shaped racks for larger substrates where the support may be required at two or more than two points. As an example the support plate 420A (see FIG. 4A) and its counterpart are “L” shaped. Provisions can be made to attach grooved brace sections on both arms of the “L”. Such racks can also be stacked when empty by nesting. Inexpensive racks may be substantially made out of one piece sheet metal by stamping grooves in a design according to this disclosure, tabs, etc., and bending them in a “U” shape. From the side these racks would appear as seen in FIG. 6A. These would replace 570A and 572A in FIG. 5A. Such racks may even be molded out of plastics. Such racks for low temperature use can be produced in large quantities at very modest cost. Thus the concepts disclosed here are very versatile and racks in different shapes and sizes can be fabricated.

### Dip Process System

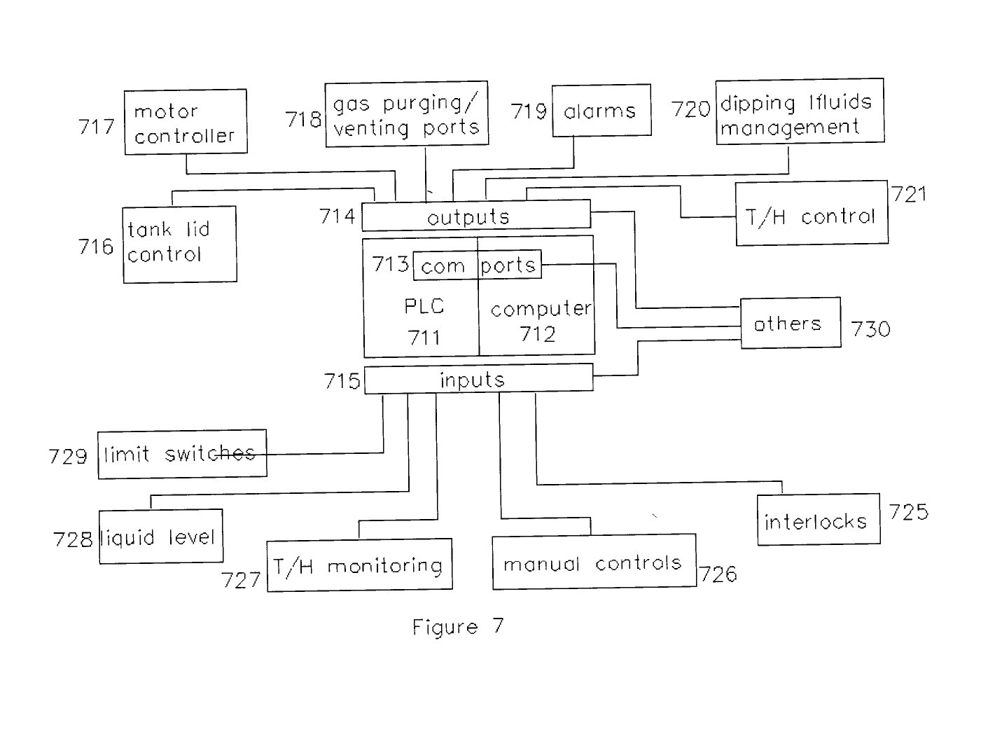

Schematics of an exemplary dip process system are described in FIG. 7. It is not necessary to incorporate all of the features described here in one system, rather these can be adapted as required by the user. A schematic of the dip machine with a tank, gripper and a substrate was described in FIGS. 1 and 2. The block diagram in FIG. 7 shows a central system which may constitute of a PLC (711) and/or computer (712). The user provides input to this system manually, e.g., by toggle switch, keypad or computer interface or combinations of these. This input may be related to the speed of immersion and withdrawal (these may be different), dwell time in the tank, stroke length to control coated area, temperature and humidity settings, multiple dipping parameters. For multiple dipping one may air-dry the coating before dipping again so that the previously deposited coating is not removed. Heat treatment and/or radiation such as UV may assist this drying or curing. For multiple dipping operation involving heat, at least one of a parallel set of hot plates or infrared heaters or an oven are typically provided just above the dip tank. For UV either an areal source or a line source is used, where the latter is moved relative to the substrate. The source may be located on one or more sides or multiple sources can be used, for 3 dimensional objects which have to have a coating on all sides. One may have a system of several tanks, where coatings with different compositions are deposited on top of each other as a stack. One preferred way is to either mount the tanks on a rotating carousel, so that they can be rotated and positioned under the moving slide, or the slide is rotated to dip in various tanks placed around this moving slide post. In one embodiment for automation a robotic arm may lift a substrate from a rack, rotate in the dip position, dip, rotate for drying or processing in another position and then place the substrate in an outgoing rack without operator intervention. This process can be repeated continuously.

The dipping mechanism (consisting of at least the dip tank opening and the environment from which the substrate is inserted in the dip tank and withdrawn) can also be put in a environmental chamber where the temperature, humidity, gas, vapors and particulates may be controlled. This allows the substrates to be conditioned to a fixed temperature and humidity before coating and also allows the coatings to dry under consistent conditions when they are pulled out of the tank without attracting the particulates on the wet surfaces. Typically the air is cleaned using HEPA filters (or a clean source is used) before being introduced in the environmental chamber, and a typical specification may be to remove particulates down to 0.3 microns or finer. Another feature which can be put in the chamber is a static equalizer such as a static dissipation bar which generates oppositely charged ions (Simco (Hatfield, Pa.) sells a variety of products such as static elimination bars and guns suitable for this purpose). This feature is particularly useful to keep particles from being attracted to the substrate due to static attraction. The usefulness of this feature increases at low humidities, particularly if humidity levels lower than 30% are maintained in the chamber. In order to put a dipping mechanism inside the chamber, it is usually preferred to put the entire dip tank and the slide mechanisms on a table top in a volume shown as 190C in FIG. 1C and then provide a chamber all around as shown by 140C. The chamber can have doors and portholes with gloves etc. to load and unload the chamber (not shown), and to manipulate the objects inside the chamber without disturbing the atmosphere. Once a substrate is loaded and the door closed, a sensor senses the event and waits for the atmosphere (in volume 190C) to be purged and to be brought to the desired environmental conditions before automatically starting the dipping process.

During the process, manual inputs may be required to start/stop processes, load, unload substrates, etc, which may be accomplished by pressing buttons, switches, foot pedals, etc. These are shown as 726. There are several other inputs being provided to the machine such as activation of limit switches (729), liquid level in the dip tank (728), temperature/humidity in the controlled environment (in the chamber volume where substrate is pulled out from the tank) (727), interlocks (such as safety switches, open doors to controlled environment area) (725) and others (730). Examples of others (730) include particulate contamination level inside the controlled environment (volume 190C in FIG. 1C), flow of gases, gas composition, temperature of coating liquid in the tank, viscosity of the coating liquid, particulates in the coating liquid, multiple dipping variables, coating thickness, spectroscopic information on the coating being deposited and on the coating liquid to monitor chemical changes, etc. The other inputs may be routed through 715 or through a communication port 713 such as RS232, GPIB, USB and IEEE1394, field bus, or wireless modules such as those based on RF (radio frequency) and bluetooth technology. These communication ports may also provide data on any of the operational variables to a central data collection system which may be monitoring several processes such as for quality control.

All this information is processed by the PLC (711) and or the computer (712) and it is outputted to the tank lid control (716), motor controller (717), purging and venting ports/valves (718), alarms (719), dipping fluids management (720) and for controlling temperature and humidity in the control environment (721). Dipping fluid management (720) includes coating fluid level in the tank, its temperature, viscosity, contamination level and chemical composition. When any of the variables go out of the pre-set limits an alarm may sound for the operator to act such as to add more material, or the machine may do so automatically. Viscosity control may be exercised by adding combination of active ingredients and the carrier solvents. High contamination levels may stop the process and initiate a coating solution filtration step. Typical temperature control in the environment or the solution should be better than ±5° C. and environmental humidity better than ±15% relative humidity (RH) at the set points. Most preferably the solution temperature should be within ±1° C., and the environmental temperature within ±2° C. and humidity within ±5% RH.

An example of a preferred dipping system configuration is a brushless DC motor (Examples of brushless motors are HBL and FBLII series from Oriental Motors, USA (Torrance, Calif.). This motor drives a ball-screw slide for lowering and raising the substrate which is controlled by PLC (programmable logic controller such as KV series from Keyence). A preferred source of slides is a Superslide™ from Thomson Industries (Port Washington, N.Y.). The brushless DC motor provides a smooth movement so that the coating thickness is uniform. Other motors such as servo motors, DC motors and stepper motors can also be used, however, either these result in vibration or do not move smoothly or at a constant speed to give high optical quality coatings as the brushless DC motors do. This PLC also controls or processes inputs from the automatic lid on the tank, fluid level sensor in the tank and the two limit switches for maximum stroke. Other features may be door interlock to ensure that this is always closed when the machine is in operation both for safety and coating quality. Typically the parts of the dip system which accommodate the slide, including the gripper, substrates, tank etc. are located on a vibration-free platform so that the coatings are uniform, particularly for optical and other precision coatings. This platform can also house the tank locator pins described above. These can be put in a chamber with controlled environment, or a chamber may also be placed on to this table. The speed of substrate withdrawal and insertion, along with dwell times in the solution and outside (e.g., for multiple dippings) may also be programmed by the user. One may program speed changes where this substrate is being lowered or raised in several steps, and each step at various speeds, or the speed changes linearly or non-linearly in a single step of lowering or raising. In multiple coatings a user may specify different conditions of speed, dwell, etc, for each layer. Analog inputs to monitor temperature and humidity may be used to sound alarm or control atmosphere. The system of the invention may also be used for coating at an angle by tilting both the dip tank and the slide so that different coating thicknesses are formed on the front and the back surface (For example see information on “Angle dependent dip coating” from Institut Fur Neue Materialien, Saarbrucken, Germany, http://www.inmgmbh.de).

### Substrate Grippers

Substrate grippers need to have several characteristics for high performance:

1. These must grip the substrates with high positional consistency so that the coatings are deposited in precisely defined areas.

2. These need to grip the substrates at a precise angle, in most cases parallel to the vertical. A small tilt can result in large deviation at the bottom of the substrate, which becomes more serious with increasing size. This is also more critical when narrow width tanks are used.

3. These need to grip the substrate well, but not damage at the grip points.

4. They need to grip or bite onto a small area of the substrate, so that most of the substrate area can be coated.

5. Since in most cases, the coating liquid level will not come up right to the brim of the dip tank, these should have a low profile so that they can physically enter the tank to maximize the coated area of the substrate.

6. Also, these should not corrode or leave any residue on the substrate.

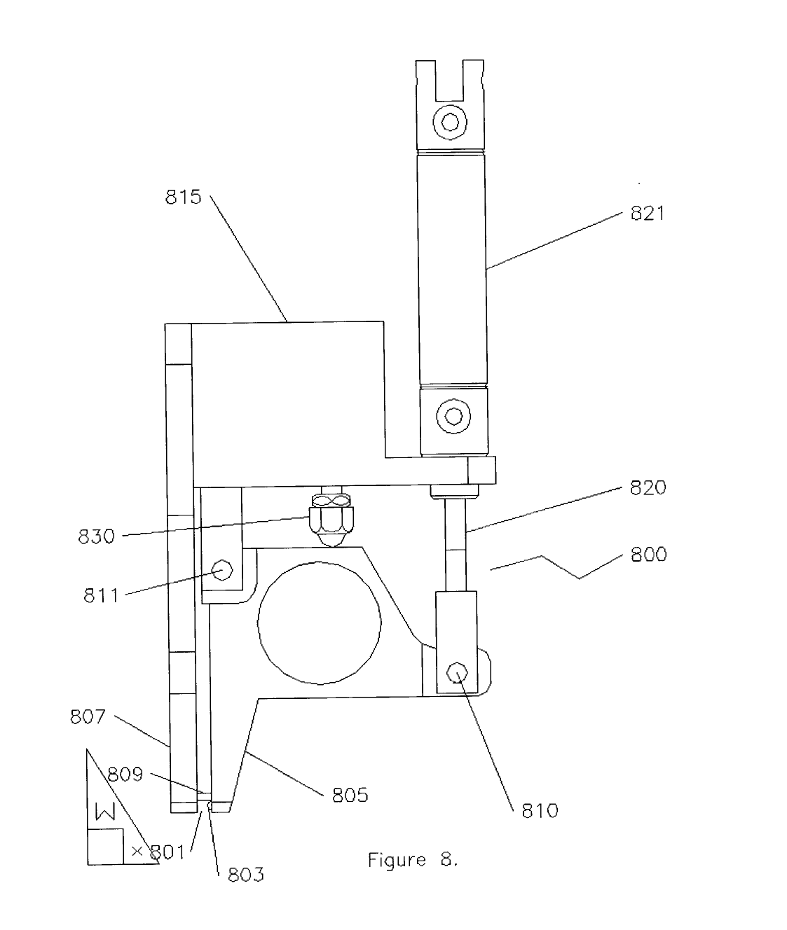

FIG. 8 shows a drawing of a gripper that accomplishes all of these functions. This is mounted to a slide or a moving platform. This gripper consists of fixed vertical plate 807 and an articulated finger 805. The fixed plate is attached to the slide of the dip coating equipment and provides a stable surface that controls the angle at which the substrate is held (in most cases vertical). The finger is hinged at a point 811 well above the gripping end. This allows the finger to open and close and remain substantially parallel to the fixed plate. The gripper contains a means of controlling the depth to which the substrate can be inserted. This is so that the coating area is consistent so long as the gripper is dipped the same distance from the dipping liquid surface. This is shown as a pair of pins 809 which are attached to the vertical plate 807 and move freely in holes in the articulated finger 809. In the open position these pins are long enough for part of the pins to still be in the articulated finger so that the substrate does not go past these pins. The substrate gripping area is shown as 801 (up to the pins 809). To improve the grip without increasing the gripping force the articulated finger has a groove that contains a short length of elastomeric material (o-ring stock) 803 that is compatible with the dipping liquid. This is called a cushion, and generally the hardness of this material will be less than Shore Hardness D90 as measured by ASTM test D2240 (American Society for Testing Materials, Philadelphia, Pa.). In normal operation the gripper never contacts the dipping liquid. The plate and the finger are both narrow in profile in order to allow the gripper to reach down into the dip tank, since the dipping liquid is generally below the top surface of the tank. The articulated finger is activated by a pneumatic cylinder 821 which drives the rod 820 and connects to it at hinge 810. The mounting block is attached to the vertical plate 807 and supports the pneumatic cylinder 821. 830 is an adjustable screw to adjust the finger 805 for the maximum opening.

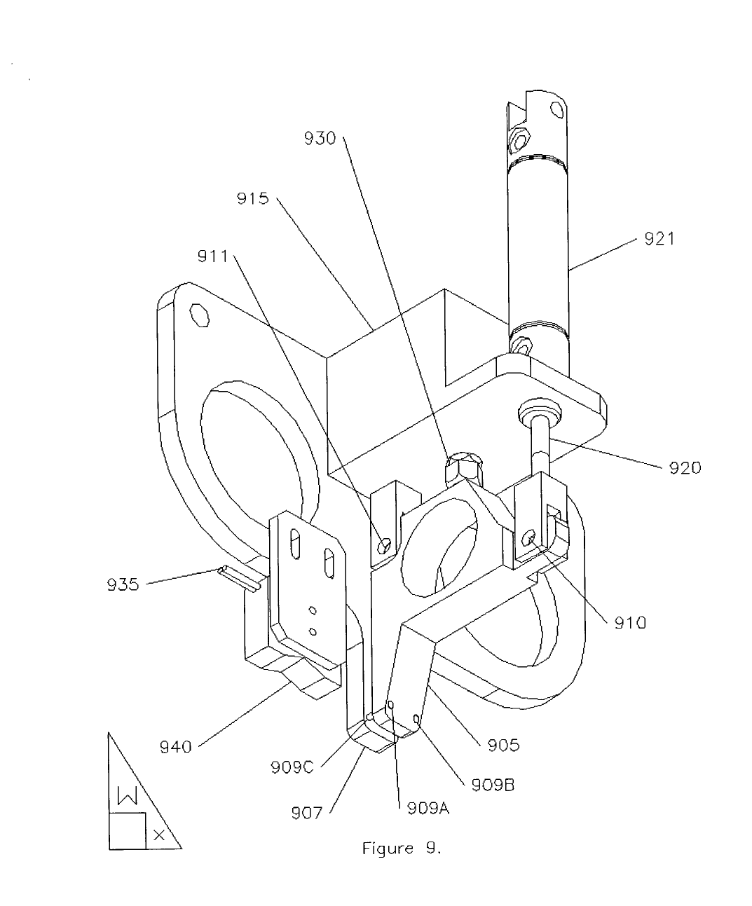

An isometric view of the gripper assembly is given in FIG. 9. Again the vertical plate is shown as 907, articulated finger as 905, the holes for the pins to restrict substrate grip area (or the depth of the substrate inserted into the gripper) are shown as 909A and 909B and one of the pins is seen as 909C. The mounting block is 915 and the pneumatic cylinder 921 is connected to the rod 920 which connects to the articulated finger at 910. The adjustable screw to adjust the maximum opening between the fixed plate and the articulated finger is shown as 930. The articulated finger connects to the mounting block by an hinge 911. In order to insure that the distance that the gripper assembly travels from the dipping liquid is consistent, a sensor is mounted to the gripper that senses the surface of the dipping liquid and its output signal is used to stop the slide. Also shown in this view is the sensor 940 along with the wires 935 for driving/sensing. This sensor is for measuring the liquid level in the dip tank as shown as 123A in FIG. 1A.

A gripper assembly was made to coat 3/32 and ⅛ inch thick glass in a size of about 15 inch by 16 inch (about 1 and 1.3 kg in weight respectively). This was gripped using a distance from the edge of about ⅛^{th} of an inch (gripping area as defined above). The gripper was designed to have to hold the substrate at two points so that it may be held parallel to the horizontal, thus two such gripping mechanisms were mounted on one frame. A substrate being held at two points is shown in FIG. 1A by 121A and 122A. Also mounted on this assembly was the sensor to measure the liquid level in the coating tank along with a striker for the limit switches, these are also shown in FIG. 1A as 123A and 124A respectively.

The gripper parts should be made from a material that will not corrode or leave any residue on the substrate. Some examples of materials: stainless steel, glass filled plastics, and chrome plated steel. The pneumatic activation is preferably done through a speed control valve (not shown), so that when the articulated finger is activated it is done at a controlled speed so as to not to damage the substrate. The finger should grip the substrate in a preferred range of 0.05 to 0.5 seconds and not instantly. As an example we used Series AS valves from SMC (Indianapolis, Ind.), in particular AS1211F.

Numerous other embodiments and variations may be conceived from the teachings of this invention by those skilled in the art. The scope of the present invention is defined by the following claims.

1. A dip coating process for coating substrates with a fluid, comprising:
gripping said substrates by a gripper attached to a moving slide, and
dipping said substrates in a fluid and withdrawing them, where the fluid is held in a dip tank and a level of the fluid in said dip tank is sensed by a sensor,
an input from said sensor being used to control the coated area of said substrate.

2. A dip coating process as in claim 1, wherein coating solution is added automatically to the dip tank to maintain the fluid level in response to said sensor.

3. A dip coating process as in claim 1, wherein more than one substrate is held in parallel and coated in one dipping step.

4. A dip coating process as in claim 1, wherein said sensor is attached to said gripper, and said gripper holds the substrate and moves the substrate in and out of the fluid in said dip tank.

5. A dip coating process as in claim 1, wherein said liquid level measuring sensor is a non-contact type.

6. A dip coating process as in claim 1, wherein said dip tank has a cover to close or open an opening through which said substrate is inserted and withdrawn from said dip tank, and wherein said cover automatically opens before said substrate enters said dip tank and then automatically closes when said substrate leaves said dip tank.

7. A dip tank for dip coating a substrate which has at least two segments of different dimensions as measured by the internal cross-section of said tank, one said segment being narrow and the other said segment being wide, wherein said narrower segment cross-section is at least greater than the cross-section of said substrate, and said wider segment has a cross-section greater than that of said narrower segment so that a volume of said wider segment is at least equal to a volume of the liquid displaced by said substrate during a dip operation.

8. A dip tank in claim 7, wherein said narrower segment of said tank is more than 2 times the width of the thickness of a sheet substrate being coated.

9. A dip tank as in claim 7, wherein the volume of the wider segment of the said tank is more than 2 times the volume of the liquid displaced by said substrate during the dip operation.

10. A dip tank as in claim 7, wherein there is a third segment between the wider and the narrower segments to allow transition from the narrower cross-section to the wider cross-section.

11. A rack for holding substrates, said rack being constructed by fastening at least two parallel structural plates by at least four rods separating said two plates, wherein said rack rests on at least two said rods which are cylindrical and are able to rotate around their axes.

12. A rack as in claim 11, wherein additional members between said parallel plates comprise grooved brace sections for holding said substrates by their edges.

13. A rack as in claim 12, wherein the cross-section of grooves in said grooved brace sections resemble an “U” in part and the distance between the parallel arms of said “U” is defined by the thickness of the substrate so that the ratio of the substrate thickness and the distance between the parallel arms of said “U” is in the range of 0.2 to 0.95.

14. A rack as in claim 13, wherein the material of said parallel arms has a coefficient of friction of less than 2.5 relative to the material of said substrate.

15. A rack as in claim 13, wherein a vertical sides of said “U” are taller than 0.002 inches.

16. A rack as in claim 15, wherein said “U” is modified to include a third section where an upper part of said vertical sides diverges in order to further increase the gap of the groove.

17. A rack for holding substrates, said rack being constructed by fastening together at least two parallel structural plates, wherein at least two grooved brace sections are located between said parallel plates to hold the edge of said substrates in said grooves, and wherein said grooved brace sections are able to toggle by a rotary action around an axis perpendicular to said structural plates.

18. A rack as in claim 17, wherein said grooved brace sections are pivoted to said structural plates on an “off centered” axis for rotation.

19. A rack as in claim 18, wherein said grooved brace section rotation is arrested in an empty rack by at least one support mounted on said structural plates.

20. A rack as in claim 19, wherein the position of said grooved brace sections is within a geometric projection of said structural support plates.

21. A rack as in claim 17, wherein said two parallel plates are separated by at least two cylindrical rods which are able to rotate around their axes and said rack rests on said rods.

22. A slide assembly having attached thereto a gripper for holding substrates, wherein said slide assembly is used to lower and raise said substrates in a dip tank and comprises a brushless DC motor to mobilize said slide assembly and a programmable controller which accepts input from a user for determining a speed to lower and raise said substrates.

23. A slide assembly as in claim 22, wherein said programmable controller includes at least one of a PLC and a computer.

24. A slide assembly as in claim 22, wherein limit switches are used to provide input to said programmable controller for stopping downward and upward movement.

25. A slide assembly as in claim 22, wherein downward movement is stopped by sensing liquid level in said dip tank.

26. A slide assembly as in claim 22 in combination with a dip coating system, wherein at least one of the following properties of coating solution temperature, coating solution viscosity, coating solution composition, particulate contamination in coating solution is measured or controlled, and the speed of the substrate travel may be changed or process stopped depending on one of said solution properties.

27. A slide assembly as in claim 22 in combination with a dip coating system, wherein a coated substrate in the process of removal or after removal from said dip tank is further processed by at least one of heat and radiation while still being held on said slide.

28. A slide assembly as in claim 22, wherein said slide assembly and said dip tank are mounted on a vibration free table.

29. A slide assembly as in claim 22, configured in a dipping system for multiple dip coatings of different materials utilizing one said slide assembly and more than one said dip tank.

30. A slide assembly as in claim 22, wherein a dipping mechanism comprising said slide assembly and at least the opening of said dip tank is housed in an enclosed chamber.

31. A slide assembly as in claim 30, including a control system to measure and control one of humidity, temperature and particulate contamination in said enclosed chamber.

32. A slide assembly as in claim 30, wherein said enclosed chamber is equipped with a static charge dissipation mechanism.

33. A slide assembly as in claim 22, which automatically adjusts a travel distance into a fluid of said dip tank based on the level of said fluid.

34. A slide assembly as in claim 33, wherein said travel distance is adjusted relative to the level of the fluid so that the coated area of dipped substrates remains same.

35. A slide assembly as in claim 22, further including a gripper assembly wherein gripping action by said gripper assembly is by an articulated finger which moves against a fixed plate.

36. A slide assembly as in claim 35, wherein said articulated finger has a cushioned element.

37. A slide assembly as in claim 35, wherein said articulated finger and said fixed plate provide a gripping action and an area of substrate inserted in said gripper is consistent.

38. A slide assembly as in claim 35, wherein a depth of substrate area inserted in said gripping element is restricted to a predefined measure.

39. A slide assembly as in claim 35, wherein said articulated finger is pneumatically activated.

40. A slide assembly as in claim 35, wherein said pneumatic activation is speed-controlled.
